(19) United States
(12) Patent Application Publication
(10) Pub. No.: US 2026/0012780 A1
(43) Pub. Date: Jan. 8, 2026

(54) COMMUNICATION DEVICE FOR INDICATING INFORMATION

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 19/322,949

(22) Filed: Sep. 9, 2025

Related U.S. Application Data
(63) Continuation of application No. PCT/CN2023/092836, filed on May 8, 2023.

(51) Int. Cl. H04W 8/24; H04W 72/02; H04W 72/0453

(52) U.S. Cl. CPC H04W 8/24; H04W 72/02; H04W 72/0453

(57) ABSTRACT

Provided is a communication device for indicating information. The communication device is a first device and the communication device includes: a processor and a memory, wherein the memory is configured to store one or more computer programs, and the processor is configured to run the one or more computer programs to: transmit first information to a second device, wherein the first information indicates a time required for the first device to switch from a first band combination to a second band combination.

### CROSS-REFERENCE TO RELATED APPLICATION

This application is a continuation of International Application No. PCT/CN2023/092836, filed May 8, 2023, the entire disclosure of which is incorporated herein by reference.

### TECHNICAL FIELD

Embodiments of the present disclosure relate to the technical field of communications, and particularly relate to a communication device for indicating information.

### RELATED ART

During switching between bands, it takes a period of time for a terminal device to complete band switching, and the terminal device may not transmit data during this period of time.

### SUMMARY

Embodiments of the present disclosure provide a communication device for indicating information.

According to some embodiments of the present disclosure, a communication device is provided. The communication device is a first device, and the communication device includes: a processor and a memory, wherein the memory is configured to store one or more computer programs, and the processor is configured to run the one or more computer programs to: transmit first information to a second device, wherein the first information indicates a time required for the first device to switch from a first band combination to a second band combination.

According to some embodiments of the present disclosure, a communication device is provided. The communication device is a second device, and the method includes: a processor and a memory, wherein the memory is configured to store one or more computer programs, and the processor is configured to run the one or more computer programs to: receive first information from a first device, wherein the first information indicates a time required for the first device to switch from a first band combination to a second band combination.

### BRIEF DESCRIPTION OF DRAWINGS

FIG. 1 is a schematic diagram of a network architecture according to some embodiments of the present disclosure;

FIG. 2 is a schematic diagram of band coverage range according to some embodiments of the present disclosure;

FIG. 3 is a schematic diagram of band switching according to some embodiments of the present disclosure;

FIG. 4 is a schematic diagram of band switching according to some embodiments of the present disclosure;

FIG. 5 is a schematic diagram of a switch time for band switching according to some embodiments of the present disclosure;

FIG. 6 is a schematic diagram of a switch time for band switching according to some embodiments of the present disclosure;

FIG. 7 is a flowchart of a method for indicating information according to some embodiments of the present disclosure;

FIG. 8 is a schematic diagram of a switch time for band switching according to some embodiments of the present disclosure;

FIG. 9 is a block diagram of an apparatus for indicating information according to some embodiments of the present disclosure;

FIG. 10 is a block diagram of an apparatus for indicating information according to some embodiments of the present disclosure; and

FIG. 11 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute any limitation on the technical solutions according to the embodiments of the present disclosure. Those of ordinary skilled in the art understand that, with the evolution of the network architecture and the emergence of new service scenarios, the technical solutions according to the embodiments of the present disclosure are also applicable to similar technical problems.

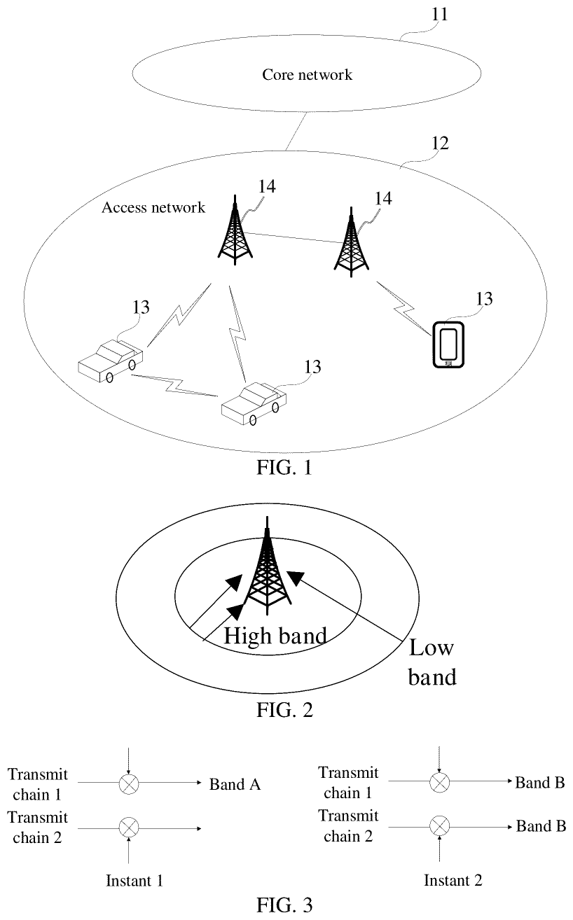

Referring to FIG. 1, a schematic diagram of a network architecture according to some embodiments of the present disclosure is illustrated. The network architecture includes: a core network 11, an access network 12, and terminal devices 13.

The core network 11 includes a plurality of core network devices. The core network devices mainly function to provide user connection, user management, and service bearing, and serve as a bearer network to provide an interface to an external network. For example, the core network of a 5th generation mobile communication (5G) new radio (NR) system includes devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionality for the terminal devices 13. The access network device 14 includes various forms of macro base stations, micro base stations, relay stations, access points, and the like. The name of the device with functionality of an access network device varies in systems employing different radio access technologies. For example, the device is referred to as a gNodeB or a gNB in the 5G NR system. With the evolution of communication technologies, the name “access network device” may change. For the convenience of description, the above apparatuses providing the wireless communication functionality for the terminal devices 13 are collectively referred to as the access network device in the embodiments of the present disclosure.

Typically, a plurality of terminal devices 13 are provided, and one or more terminal devices 13 may be arranged in a cell managed by each of the access network devices 14. The terminal devices 13 may include various handheld devices, in-vehicle devices, wearable devices, computing devices, other processing devices connected to a radio modem with the wireless communication functionality, various forms of user equipments (UEs), mobile stations (MS), and the like. For convenience of description, the devices described above are collectively referred to as the terminal devices, that is, the terminal device and the UE mentioned in the embodiments of the present disclosure have the same meaning. The access network devices 14 communicate with the core network devices using an air interface technology, such as an NG interface in the 5G NR system. The access network devices 14 communicate with the terminal devices 13 using an air interface technology, such as a Uu interface.

The terminal devices 13 (for example, the in-vehicle device and another device, such as another in-vehicle device, a mobile phone, or a road side unit (RSU)) may communicate with each other over a direct communication interface (for example, a ProSe communication 5 (PC5) interface). Accordingly, the communication link established based on the direct communication interface may be referred to as a direct link or an SL. The SL transmission means that data transmission is directly carried out between the terminal devices over an SL, which is different from a conventional cellular system in which the communication data is received or transmitted by the access network device. The SL transmission has characteristics of short delay and low overhead, and is therefore suitable for communication between two terminal devices that are geographically close to each other (such as an in-vehicle device and another peripheral device that is geographically close to the in-vehicle device). It should be noted that, in FIG. 1, only vehicle-to-vehicle communication in a vehicle-to-everything (V2X) scenario is illustrated, while the SL communication is applicable to various scenarios where terminal devices directly communicate with each other. In other words, the terminal device in the present disclosure refers to any device that communicates with another device over the SL.

The “5G NR system” in the embodiments of the present disclosure may also be referred to as a 5G system or an NR system, but those skilled in the art can understand the meaning thereof. The technical solutions according to the embodiments of the present disclosure are applicable to the 5G NR system, and also to evolved systems of the 5G NR system.

Before description of the technical solutions of the present disclosure, some background technical knowledge involved in the present disclosure is first explained. The following related technologies may be combined with the technical solutions according to the embodiments of the present disclosure in any manner, all of which fall within the scope of protection of the embodiments of the present disclosure. The embodiments of the present disclosure include at least some of the following content.

### 1. Switched Transmission

Under the same transmit power, space propagation loss is lower and cell coverage is generally larger in a low band, as illustrated in FIG. 2. In contrast, in a high band, because space propagation loss is larger, cell coverage is smaller under the same transmit power, but the bandwidth and capacity are larger, and generally uplink multiple-in multiple-output (MIMO) may be achieved.

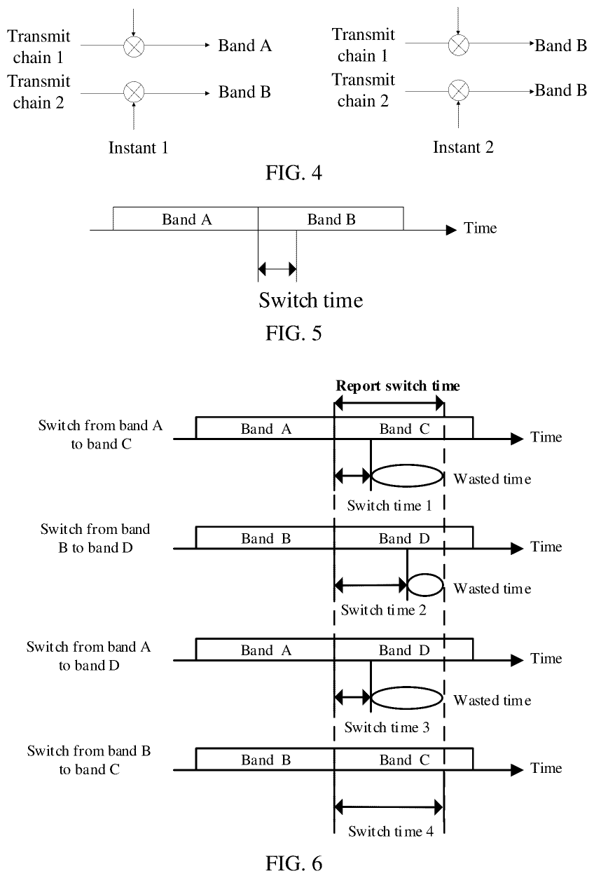

Therefore, one way to take full advantages of the wide coverage at the low band and the larger capacity in the high band is to combine the two bands for use. However, in terms of hardware, a terminal device generally may only support two concurrent chains. In a case where the low band occupies one transmit chain, the high band may only use the other transmit chain. Consequently, the advantage of the combination of the low band and the high band may not be used. Therefore, uplink switched transmission is an effective implementation, that is, transmission is switched between a low band and a high band. As illustrated in FIG. 3, transmission is performed at a low band (band A) at instant 1, and transmission is performed at the high band (band B) at instant 2. Alternatively, as illustrated in FIG. 4, simplex transmission is performed at the low band (band A) and at the high band (band B) at instant 1, and duplex transmission is performed at the high band (band B) at instant 2. In this way, the characteristics of wide coverage at the low band and the MIMO capability and larger bandwidth at the high band can be fully used.

### 2. Switch Time

In the switched transmission scenario, the terminal device needs to adjust the operating frequency and parameter setting of the transmit chain, which takes some time. Therefore, when the transmit chain of the terminal device is switched from band A to band B, seamless switching may not be achieved and the switching takes some time for adjustment, as illustrated in FIG. 5. Generally, the terminal device reports the time for adjustment based on a band pair. Subsequent to receiving the reporting, the base station knows how long it takes for adjustment for the terminal device to switch on the band pair, and the terminal device may not perform effective transmission during this period of time.

In a case where the above switched transmission is expanded to switched transmission among a plurality of bands, the time is more complex. For example, the terminal device performs transmission in band A and band B at instant 1, and thereafter, the terminal device performs transmission in band C and band D at instant 2. A plurality of switch modes support switching from band A and band B to band C and band D, for example, switching from band A to band C and switching from band B to band D; or switching from band A to band D and switching from band B to band C, or the like. When the terminal device indicates to a network that the terminal device is switched from band A and band B to band C and band D, in the related art, the longest time among the switch time for switching from band A to band C, the switch time for switching from band A to band D, the switch time for switching from band B to band C, and the switch time for switching from band B to band D is taken as the switch time required by the terminal device.

The above method is simple because there is no need to know whether the terminal device is switched from band A to band C or band D and is switched from band B to band D or band C, and the implementations are different for different terminal devices. However, in a case where the switch time for switching from band A to band C, the switch time for switching from band A to band D, the switch time for switching from band B to band C, and the switch time for switching from band B to band D differ greatly from each other, for example, 35 μs, 140 μs, and 210 μs, even though the switch time is only 35 μs between two band pairs, 210 μs is still adopted, which actually results in a great waste of switch time because the terminal device may not transmit effective data during the switch time.

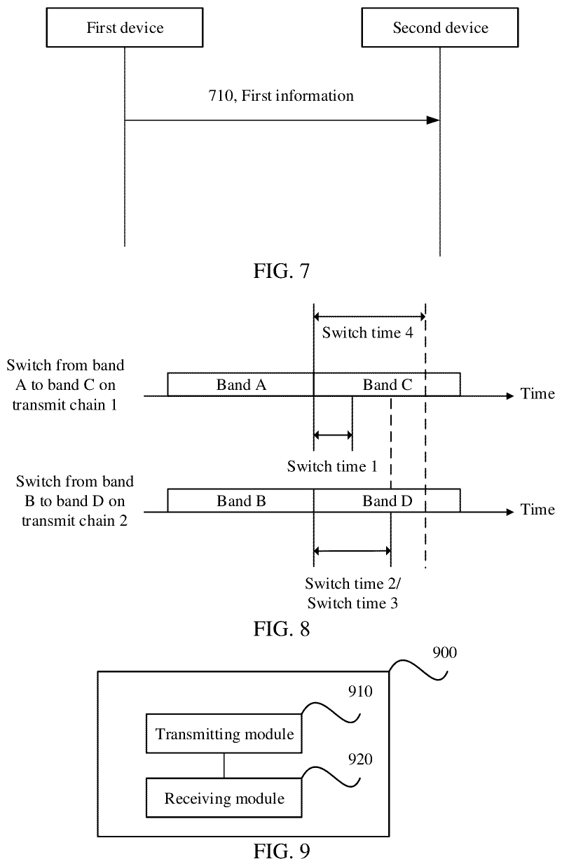

FIG. 7 illustrates a flowchart of a method for indicating information according to some embodiments of the present disclosure. The method is applicable to the network architecture illustrated in FIG. 1. The method includes the following process 710.

In process 710, a first device transmits first information to a second device.

Accordingly, the second device receives the first information from the first device.

The first information indicates a time required for the first device to switch from a first band combination to a second band combination.

In some embodiments, the first device is a terminal device and the second device is a network device.

In a case where the first device is a terminal device and the second device is a network device, the first device transmits the first information over an uplink to the second device.

In some embodiments, the second device is a network device in a terrestrial network (TN) such as a cellular network, e.g., a base station, or the second device is a network device in a non-terrestrial network (NTN), e.g., a satellite.

In some embodiments, the first device and the second device are two different terminal devices.

In a case where the first device and the second device are both terminal devices, the first device transmits the first information over a sidelink to the second device.

In some embodiments, the first information indicates the time required for the first device to switch from the first band combination to the second band combination. The time required for the first device to switch from the first band combination to the second band combination may be understood as the time taken cost by the first device to switch from the first band combination to the second band combination. In some embodiments, the first information indicates the minimum time required for completing the band switching on all transmit chains of the first device or indicates the switch time respectively corresponding to the transmit chains of the first device.

In some embodiments, the first device needs to perform band switching on n transmit chains to switch from the first band combination to the second band combination, where n is a positive integer.

Exemplarily, the first band combination includes band A and band B, and the second band combination includes band A and band A. In this case, the first device needs to perform band switching on one transmit chain.

Exemplarily, the first band combination includes band A and band B, and the second band combination includes band A and band C. In this case, the first device may need to perform band switching on one transmit chain or may need to perform band switching on two transmit chains. For example, the first device is switched from band B to band C, and the first device needs to perform band switching on only one transmit chain. For another example, the first device is switched from band A to band C and switched from band B to band A, and the first device needs to perform band switching on two transmit chains.

Exemplarily, the first band combination includes band A and band B, and the second band combination includes band C and band D. In this case, the first device needs to perform band switching on two transmit chains.

In some embodiments, the first information further includes a first number, wherein the first number is the number of transmit chains of the first device after the first device is switched from the first band combination to the second band combination.

The first device has one or more transmit chains. Exemplarily, the first number is 1, 2, 3, 4, or the like.

In some embodiments, at least one of the first band combination or the second band combination includes at least two bands.

Exemplarily, the first band combination includes one band, and the second band combination includes at least two bands. For example, the first band combination includes band A, and the second band combination includes band B and band C.

Exemplarily, the first band combination includes at least two bands, and the second band combination includes at least two bands. For example, the first band combination includes band A and band B, and the second band combination includes band C and band D.

Exemplarily, the first band combination includes at least two bands, and the second band combination includes one band. For example, the first band combination includes band A and band B, and the second band combination includes band C.

In some embodiments, the first information is carried in capability information transmitted from the first device to the second device, wherein the capability information indicates the time required for switching to at least one band combination.

In some embodiments, the switching at least one band combination includes switching from the first band combination to the second band combination. The switching at least one band combination may further include switching between other band combinations, e.g., switching from the first band combination to a third band combination, switching from the second band combination to the third band combination, and the like.

Exemplarily, the capability information includes a plurality of pieces of first information. At least one piece of the plurality of pieces of first information indicates the time required for the first device to switch from the first band combination to the second band combination, and the other pieces of first information indicate the time required for switching between other band combinations.

The capability information carrying the first information is not limited in the present disclosure. For example, the capability information is capability information in an initial access procedure. For another example, the first device transmits the first information over radio resource control (RRC) signaling to the second device in the initial access procedure. That is, the first information is carried in the RRC signaling.

According to the above method, the second device may know from the capability information the time required for the first device to switch from the first band combination to the second band combination, thereby avoiding the waste of time resources.

In some embodiments, the first information is transmitted by the first device upon determining that the first device is switched from the first band combination to the second band combination. In some embodiments, the first information is transmitted by the first device upon determining the bands that the first device is switched to on the n transmit chains respectively.

Exemplarily, the first band combination includes band A and band B, and the second band combination includes band C and band D. Upon determining that the first device is switched from band A to band D and switched from band B to band C, the first device transmits the first information.

In some embodiments, the first information includes a first switch time, wherein the first switch time is determined based on the switch times respectively corresponding to the n transmit chains.

In some embodiments, the first information is transmitted over an RRC reconfiguration complete message to the second device. That is, the first information is carried in the RRC reconfiguration complete message.

Exemplarily, the first device transmits the first information over the RRC reconfiguration complete message to the second device after the second device completes the band combination configurations such as carrier aggregation (CA) and dedicated control (DC) for the first device.

According to the above method, the second device may know an exact time required by the first device for band switching, thereby precisely scheduling the transmit chain of the first device.

In the technical solutions according to the embodiments of the present disclosure, the first information is provided by the first device to the second device, and the first information indicates the time required for the first device to switch from the first band combination to the second band combination. Therefore, the second device may know the time required for the first device to switch from the first band combination to the second band combination, and arrange a time appropriately for data transmission. Thus, the waste of time resources is avoided, and the throughput of data transmission is improved.

In some embodiments, the first information indicates a minimum time required for the first device to complete band switching on various transmit chains or indicates switch times respectively corresponding to the various transmit chains of the first device.

In some embodiments, the first information includes a first switch time, wherein the first switch time is determined based on the switch times respectively corresponding to the n transmit chains.

In some embodiments, the first switch time is a maximum of the switch times respectively corresponding to the n transmit chains.

For example, the switch times respectively corresponding to the n transmit chains are 35 μs, 140 μs, and 210 μs, and the first switch time is 210 μs.

For example, the switch times respectively corresponding to the n transmit chains are 35 μs, 140 μs, and 140 μs, and the first switch time is 140 μs.

Illustrative description is given hereinafter by an example where the first device has two transmit chains, the first band combination includes band A and band B, and the second band combination includes band C and band D.

For example, the first device is switched from the first band combination to the second band combination, which includes two cases. In a first case, the first device is switched from band A to band C on transmit chain 1, and switched from band B to band D on transmit chain 2. In a second case, the first device is switched from band A to band D on transmit chain 1, and switched from band B to band C on transmit chain 2.

As illustrated in FIG. 8, the switch time required for switching from band A to band C is switch time 1, the switch time required for switching from band B to band D is switch time 2, the switch time required for switching from band A to band Dis switch time 3, and the switch time required for switching from band B to band C is switch time 4. The switch time 1 is less than switch time 2, switch time 2 is equal to switch time 3, and switch time 3 is less than switch time 4, that is, switch time 4 is a maximum.

In the related art, the second device determines the time required for the first device to complete the band switching based on switch time 4.

In the embodiments of the present disclosure, upon determining the bands that the first device is switched to on the n transmit chains respectively, the first device transmits the first information to the second device. For example, subsequent to determining the first device is switched from band A to band C and switched from band B to band D, the first device transmits the first information to the second device, and the first information includes the first switch time. In this case, the first switch time is switch time 2.

In some embodiments, the method further includes process 720 following process 710.

In process 720, in a case where it is determined based on the first switch time that the band switching has been completed on the n transmit chains, the second device transmits third information to the first device, wherein the third information is configured to schedule transmission on the n transmit chains.

Accordingly, the first device receives the third information from the second device.

The third information is configured to schedule transmission on the n transmit chains or schedule transmission on any one or more of the n transmit chains.

Subsequent to receiving the first information, the second device schedules the first device to transmit data at the end of the switch time indicated by the first information. Using FIG. 8 as an example, via reporting of the first information, the second device schedules the data transmission in band C and band D on two transmit chains respectively at the end of switch time 2, without waiting to perform data transmission in band C and band D until the end of switch time 4.

In the embodiments of the present disclosure, the second device may only determine based on the first switch time that the band switching has been completed on the n transmit chains, but may not accurately determine whether the band switching has been completed on a certain transmit chain. Therefore, the first information does not need to indicate the band pair information respectively corresponding to the n transmit chains, and the second device is unaware of the switching situation on the n transmit chains. The band pair information corresponding to the transmit chain indicates a band that the first device is switched from and a band that the first device is switched to on the transmit chain.

According to the above method, the first device indicates, over the first information, to the second device the minimum time required for completing the switching on all transmit chains of the first device, and the second device does not need to wait until the end of a maximum switch time. In this way, the waste of time resource is avoided to some extent, and the throughput of data transmission is improved. The maximum switch time refers to a maximum switch time in all possible switch times required for the first device to switch from the first band combination to the second band combination.

In some embodiments, the first information includes switch time respectively corresponding to n transmit chains.

Illustrative description is given hereinafter by an example where the first device has two transmit chains, the first band combination includes band A and band B, and the second band combination includes band C and band D.

As illustrated in FIG. 7, the switch time required for switching from band A to band C is switch time 1, the switch time required for switching from band B to band D is switch time 2, the switch time required for switching from band A to band Dis switch time 3, and the switch time required for switching from band B to band C is switch time 4. Switch time 1 is less than switch time 2, switch time 2 is equal to switch time 3, and switch time 3 is less than switch time 4, that is, switch time 4 is a maximum.

In a case where transmit chain 1 is switched from band A to band C, and transmit chain 2 is switched from band B to band D, the first information includes switch time 1 and switch time 2.

In a case where transmit chain 1 is switched from band A to band D, and transmit chain 2 is switched from band B to band C, the first information includes switch time 3 and switch time 4.

In some embodiments, the first information further includes band pair information respectively corresponding to the n transmit chains, and the band pair information corresponding to the transmit chain indicates a band that the first device is switched from and a band that the first device is switched to on the transmit chain.

Exemplarily, the first information includes switch time 1 required for switching from band A to band C on the transmit chain 1 and switch time 2 required for switching from band B to band D on transmit chain 2.

Exemplarily, the first information includes that transmit chain 1 is switched from band A to band D and that transmit chain 2 is switched from band B to band C.

Exemplarily, the first information includes switch time 3 required for switching from band A to band D on transmit chain 1 and switch time 4 required for switching from band B to band C on transmit chain 2.

In some embodiments, the first device has m transmit chains. The band switching has occurred on n transmit chains of the m transmit chains, and the first information includes the switch times respectively corresponding to the n transmit chains. In a case where a transmit chain is not included in the first information, band switching does not occur on the transmit chain. Herein, m is an integer greater than or equal to n.

For example, the first device switches from transmitting data in band A on both transmit chain 1 and transmit chain 2 to transmitting data in band A on transmit chain 1 and transmitting data in band B on transmit chain 2. Herein, band switching does not occur on transmit chain 1, and the first information does not include transmit chain 1. For example, the first information indicates the time required for switching from band A to band B on the transmit chain 2.

For example, the band switching does not occur on transmit chain 1, and the first information does not include the switch time corresponding to transmit chain 1.

In some embodiments, after the process 710, the method further includes a process 730.

In the process 730, in a case where the second device determines that band switching has been completed on a first transmit chain, the second device transmits second information to the first device, wherein the second information is used to schedule transmission on the first transmit chain.

Accordingly, the first device receives the second information from the second device.

In some embodiments, band switching having being completed on the first transmit chain is determined by the second device based on the switch time corresponding to the first transmit chain.

Subsequent to receiving the first information, the second device schedules the first device to transmit data at the end of the switch time indicated by the first information. Using FIG. 8 as an example, via reporting of the first information, the second device schedules the data transmission in band C on transmit chain 1 at the end of switch time 1, and schedules the data transmission in band D on transmit chain 2 at the end of switch time 2.

According to the above method, the second device can precisely schedule the n transmit chains of the first device, without waiting for completion of the band switching on all transmit chains. In this way, the time resources are further saved, and the throughput of data transmission is improved.

In some embodiments, the first information includes a switch time corresponding to a first transmit chain of the n transmit chains.

In some embodiments, the first information includes the switch time corresponding to one first transmit chain or the switch times respectively corresponding to a plurality of first transmit chains, which is not limited in the present disclosure.

In some embodiments, the first information includes part or all of the n transmit chains, which is not limited in the present disclosure.

Illustrative description is given hereinafter by an example where the first device has two transmit chains, the first band combination includes band A and band B, and the second band combination includes band C and band D.

As illustrated in FIG. 8, the switch time required for switching from band A to band C is switch time 1, the switch time required for switching from band B to band D is switch time 2, the switch time required for switching from band A to band Dis switch time 3, and the switch time required for switching from band B to band C is switch time 4. Switch time 1 is less than switch time 2, switch time 2 is equal to switch time 3, and switch time 3 is less than switch time 4, that is, switch time 4 is a maximum.

In a case where the transmit chain 1 is switched from band A to band C, and transmit chain 2 is switched from band B to band D, the first information includes switch time 1 corresponding to first transmit chain 1 and switch time 2 corresponding to transmit chain 2, or the first information includes switch time 1 corresponding to the transmit chain 1, or the first information includes switch time 2 corresponding to transmit chain 2.

In some embodiments, the first information further includes band pair information corresponding to the first transmit chain, and the band pair information corresponding to the first transmit chain indicates a band that the first device is switched from and a band that the first device is switched to on the first transmit chain.

Exemplarily, the first information includes that transmit chain 1 is switched from band A to band C.

Exemplarily, the first information includes that transmit chain 2 is switched from band B to band D.

Exemplarily, the first information includes that transmit chain 1 is switched from band A to band C and that transmit chain 2 is switched from band B to band D.

In some embodiments, subsequent to process 710, the method further includes process 730.

In process 730, in a case of determining that band switching has been completed on the first transmit chain, the second device transmits second information to the first device, wherein the second information is configured to schedule transmission on the first transmit chain.

Accordingly, the first device receives the second information from the second device.

In some embodiments, the second device determines, based on the switch time corresponding to the first transmit chain, whether the band switching has been completed on the first transmit chain.

Exemplarily, subsequent to receiving the first information from the first device, the second device starts counting, and determines that the band switching has been completed on the first transmit chain when the count reaches the switch time for the first transmit chain that is indicated by the first information.

Exemplarily, subsequent to receiving the first information from the first device, the second device determines, based on the switch time for the first transmit chain that is indicated by the first information, the instant of completing the band switching on the first transmit chain, thereby determining whether the band switching has been completed on the first transmit chain.

Subsequent to receiving the first information, the second device schedules the first device to transmit data information at the end of the switch time indicated by the first information. Using FIG. 8 as an example, in a case where the first transmit chain is the transmit chain 1, via reporting of the first information, the second device schedules the data transmission in band C on transmit chain 1 at the end of switch time 1. In a case where the first transmit chain is transmit chain 2, via reporting of the first information, the second device schedules the data transmission in band D on the transmit chain 2 at the end of switch time 2. In a case where transmit chain 1 and transmit chain 2 are both the first transmit chains, via reporting of the first information, the second device schedules the data transmission in band C on transmit chain 1 at the end of switch time 1, and schedules the data transmission in band D on transmit chain 2 at the end of switch time 2.

According to the above method, the second device may precisely schedule the first transmit chains of the first device, without waiting for completion of the band switching on all transmit chains. In this way, the time resources are further saved, and the throughput of data transmission is improved.

In some embodiments, the first information is defined as different information based on the content included therein. For example, in a case where the first information includes a first switch time, the first information is defined as a transmit switch period band combination (TxSwitchPeriodBandCombination). For another example, in a case where the first information includes switch times respectively corresponding to the n transmit chains, the first information is defined as a transmit switch period per transmit chain (TxSwitchPeriodPerTxChain). For another example, in a case where the first information includes a switch time corresponding to a first transmit chain, the first information is defined as a transmit switch period per transmit chain (TxSwitchPeriodPerTxChain).

Taking an example where the first device has two transmit chains, the first band combination includes band A and band B, and the second band combination includes band C and band D, the first device is switched from the first band combination to the second band combination, and the first information includes:

```
TxSwitchPeriodPerTxChain
{
  TxChainNumber {2, 3, 4};
  TxChain1:
  SwitchedFromBand {band A};
  SwitchedToBand {band C};
  SwitchPeriod  {35 μs};
  TxChain2:
  SwitchedFromBand {band B};
  SwitchedToBand {band D};
  SwitchPeriod  {140 μs};
}
```

The above content of the first information is merely illustrative. The first information may include part of the above content, and may also include other content, which is not limited in the present disclosure.

Illustrative description is given above by an example where the first information indicates the time required for the first device to switch from the first band combination to the second band combination. In some embodiments, the first information indicates the moment when the first device completes the switching from the first band combination to the second band combination. Exemplarily, the first information indicates a first instant, and the terminal device completes the band switching on all transmit chains at the first instant. In some embodiments, the first moment is a last instant of the instants when the first device completes the band switching on the n transmit chains respectively. Exemplarily, the first information indicates second moments respectively corresponding to the transmit chains of the first device, and the second moment corresponding to the first transmit chain refers to the moment when the band switching is completed on the first transmit chain. For details of this method, reference may be made to the above embodiments, which are not elaborated herein.

In the method embodiments described above, the technical solutions according to the present disclosure are merely described from the perspective of the interaction between the first device and the second device. The above processes performed by the first device may be individually implemented as a method for indicating information at the first device, and the above processes performed by the second device may be individually implemented as a method for indicating information at the second device. Additionally, the embodiments provided in the present disclosure may be combined randomly to form new embodiments, all of which fall within the protection scope of the present disclosure.

Hereinafter, apparatus embodiments of the present disclosure are illustrated, which may be configured to implement the method embodiments of the present disclosure. For details not disclosed in the apparatus embodiments of the present disclosure, reference may be made to the method embodiments of the present disclosure, which are not elaborated herein.

FIG. 9 illustrates a block diagram of an apparatus 900 for indicating information according to some embodiments of the present disclosure. The apparatus has the function of implementing the method embodiments for indicating information. The function may be implemented by hardware or implemented by software executed by relevant hardware. The apparatus may be the first device described above or may be provided in the first device. As illustrated in FIG. 9, the apparatus 900 includes a transmitting module 910.

The transmitting module 910 is configured to transmit first information to a second device, wherein the first information indicates a time required for a first device to switch from a first band combination to a second band combination.

In some embodiments, the first device needs to perform band switching on n transmit chains to switch from the first band combination to the second band combination, n being a positive integer; wherein the first information includes a first switch time, wherein the first switch time is determined based on switch times respectively corresponding to the n transmit chains.

In some embodiments, the first switch time is a maximum of the switch times respectively corresponding to the n transmit chains.

In some embodiments, the first device needs to perform band switching on n transmit chains to switch from the first band combination to the second band combination, n being a positive integer; wherein the first information includes switch times respectively corresponding to the n transmit chains.

In some embodiments, the first information further includes band pair information respectively corresponding to the n transmit chains, wherein the band pair information corresponding to each of the transmit chains indicates a band that the first device is switched from and a band that the first device is switched to on the transmit chain.

In some embodiments, he first device needs to perform band switching on n transmit chains to switch from the first band combination to the second band combination, n being a positive integer; wherein the first information includes a switch time corresponding to a first transmit chain of the n transmit chains.

In some embodiments, the first information further includes band pair information corresponding to the first transmit chain, wherein the band pair information corresponding to the first transmit chain indicates a band that the first device is switched from and a band that the first device is switched to on the first transmit chain.

In some embodiments, as illustrated in FIG. 9, the apparatus 900 further includes: a receiving module 920, configured to receive second information from the second device, wherein the second information is configured to schedule transmission on a first transmit chain of the n transmit chains, and the second information is transmitted by the second device upon determining that band switching has been completed on the first transmit chain.

In some embodiments, the band switching having been completed on the first transmit chain is determined based on a switch time corresponding to the first transmit chain.

In some embodiments, the first information further includes a first number, wherein the first number is a number of transmit chains of the first device after the first device is switched from the first band combination to the second band combination.

In some embodiments, at least one of the first band combination or the second band combination includes at least two bands.

In some embodiments, the first device is a terminal device, and the second device is a network device; or the first device and the second device are two different terminal devices.

In some embodiments, the first information is carried in capability information transmitted from the first device to the second device, wherein the capability information indicates a time required for switching to at least one band combination.

In some embodiments, the first information is transmitted by the first device upon determining that the first device is switched from the first band combination to the second band combination.

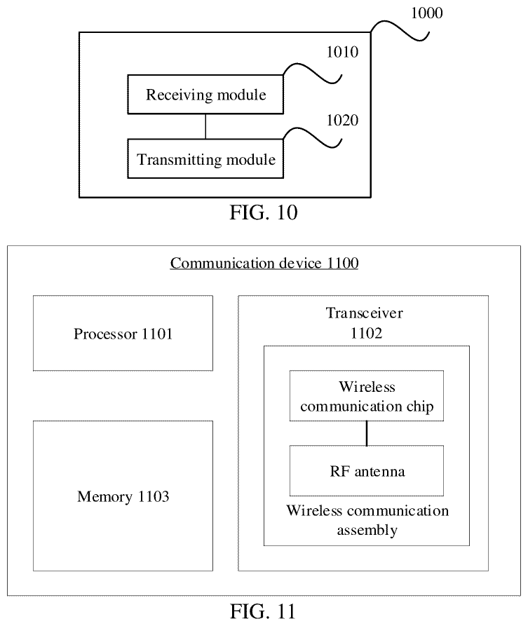

FIG. 10 illustrates a block diagram of an apparatus for indicating information according to some embodiments of the present disclosure. The apparatus has the function of implementing the above method embodiments for indicating information. The function may be implemented by hardware or implemented by software executed by relevant hardware. The apparatus may be the second device described above or may be provided in the second device. As illustrated in FIG. 10, the apparatus 1000 includes a receiving module 1010.

The receiving module 1010 is configured to receive first information from a first device, wherein the first information indicates a time required for the first device to switch from a first band combination to a second band combination.

In some embodiments, the first device needs to perform band switching on n transmit chains to switch from the first band combination to the second band combination, n being a positive integer; wherein the first information includes a first switch time, wherein the first switch time is determined based on switch times respectively corresponding to the n transmit chains.

In some embodiments, the first switch time is a maximum of the switch times respectively corresponding to the n transmit chains.

In some embodiments, the first device needs to perform band switching on n transmit chains to switch from the first band combination to the second band combination, n being a positive integer; wherein the first information includes switch times respectively corresponding to the n transmit chains.

In some embodiments, the first information further includes band pair information respectively corresponding to the n transmit chains, wherein the band pair information corresponding to each of the transmit chains indicates a band that the first device is switched from and a band that the first device is switched to on the transmit chain.

In some embodiments, the first device needs to perform band switching on n transmit chains to switch from the first band combination to the second band combination, n being a positive integer;

wherein the first information includes a switch time corresponding to a first transmit chain of the n transmit chains.

In some embodiments, the first information further includes band pair information corresponding to the first transmit chain, wherein the band pair information corresponding to the first transmit chain indicates a band that the first device is switched from and a band that the first device is switched to on the first transmit chain.

In some embodiments, as illustrated in FIG. 10, the apparatus 1010 further includes: a transmitting module 1020, configured to transmit second information to the first device upon determining that band switching has been completed on a first transmit chain, wherein the second information is configured to schedule transmission on the first transmit chain.

In some embodiments, the band switching having been completed on the first transmit chain is determined based on a switch time corresponding to the first transmit chain.

In some embodiments, the first information further includes a first number, wherein the first number is a number of transmit chains of the first device after the first device is switched from the first band combination to the second band combination.

In some embodiments, at least one of the first band combination or the second band combination includes at least two bands.

In some embodiments, the first device is a terminal device, and the second device is a network device; or the first device and the second device are two different terminal devices.

In some embodiments, the first information is carried in capability information transmitted from the first device to the second device, wherein the capability information indicates a time required for switching to at least one band combination.

In some embodiments, the first information is transmitted by the first device upon determining that the first device is switched from the first band combination to the second band combination.

It should be noted that in the case where the apparatus according to the above embodiments implements its functions, the division of the functional modules is only for illustrative purposes. In practice, the functions may be distributed to different functional modules based on actual needs, that is, the internal structure of the apparatus may be divided into different functional modules to complete all or part of the functions described above.

Regarding the apparatus in the above embodiments, the specific way in which each module performs operations has been described in detail in the relevant method embodiments, and is not described any further.

FIG. 11 illustrates a schematic structural diagram of a communication device according to some embodiments of the present disclosure. The communication device 1100 includes a processor 1101, a transceiver 1102, and a memory 1103. The transceiver 1102 is configured to implement the functions of the transmitting module 910, the receiving module 920, the receiving module 1010, and the transmitting module 1020 as described above.

The processor 1101 includes one or more processing cores, and achieves various functional applications and information processing by running software programs and modules. The processor 1101 is configured to perform processes performed by the terminal device other than the transmitting and receiving processes in the above method embodiments.

The transceiver 1102 includes a receiver and a transmitter. For example, the receiver and the transmitter may be implemented as the same wireless communication assembly. The wireless communication assembly includes a wireless communication chip and a radio frequency (RF) antenna. The transceiver 1102 is configured to perform the transmitting and/or receiving processes performed by the terminal device in the above method embodiments.

The memory 1103 is communicably connected to the processor 1101 and the transceiver 1102.

The memory 1103 is configured to store one or more computer programs run by a processor, and the processor 1101 is configured to run the one or more computer programs to perform various processes in the above method embodiments.

In addition, the memory 1103 is practiced by any type of volatile or non-volatile storage device or combinations thereof. The volatile or non-volatile storage device includes but is not limited to a magnetic disk or an optical disk, an electrically erasable programmable read-only memory (EEPROM), an erasable programmable read-only memory (EPROM), a solid-state random-access memory (RAM), a read-only memory (ROM), a magnetic memory, a flash memory, and a programmable ROM.

In some embodiments, in a case where the communication device is the first device, the transceiver 1102 of the first device is configured to transmit first information to the second device, and the first information indicates a time required for the first device to switch from a first band combination to a second band combination.

In some embodiments, in a case where the communication device is the second device, the transceiver 1102 of the second device is configured to receive first information from the first device, and the first information indicates a time required for the first device to switch from a first band combination to a second band combination.

For details not disclosed in the present embodiment, please refer to the above embodiments, which are not repeated any further herein.

Some embodiments of the present disclosure further provide a computer-readable storage medium storing one or more computer programs, wherein the one or more computer programs, when run by a processor, cause the processor to perform the method for indicating information described above. In some embodiments, the computer-readable storage medium includes a ROM, a RAM, a solid-state drive (SSD), an optical disk or the like. The RAM includes a resistance random access memory (ReRAM) and a dynamic random access memory (DRAM).

Some embodiments of the present disclosure further provide a chip. The chip includes a programmable logic circuit and/or one or more program instructions. The chip, when running, is configured to perform the method for indicating information described above.

Some embodiments of the present disclosure further provide a computer program product including one or more computer programs. The one or more computer programs are stored in a computer-readable storage medium, wherein the one or more computer programs, when loaded and run by a processor, causes the processor to perform the method for indicating information described above.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communication field including, for example, an LTE protocol, an NR protocol, and related protocols applied in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A communication device, wherein the communication device is a first device and the communication device comprises:
a processor and a memory, wherein the memory is configured to store one or more computer programs, and the processor is configured to run the one or more computer programs to:
transmit first information to a second device, wherein the first information indicates a time required for the first device to switch from a first band combination to a second band combination.

2. The communication device according to claim 1, wherein
the first device needs to perform band switching on n transmit chains to switch from the first band combination to the second band combination, n being a positive integer.

3. The communication device according to claim 1, wherein
the first information comprises a first switch time, wherein the first switch time is a maximum of switch times respectively corresponding to n transmit chains, wherein n is a positive integer; or
the first information comprises switch times respectively corresponding to the n transmit chains, and/or band pair information respectively corresponding to the n transmit chains, wherein the band pair information corresponding to each of the transmit chains indicates a band that the first device is switched from and a band that the first device is switched to on the transmit chain; or
the first information comprises a switch time corresponding to a first transmit chain of the n transmit chains, and/or band pair information corresponding to the first transmit chain, wherein the band pair information corresponding to the first transmit chain indicates a band that the first device is switched from and a band that the first device is switched to on the first transmit chain.

4. The communication device according to claim 3, wherein the processor is further configured to run the one or more computer programs to:
receive second information from the second device, wherein the second information is configured to schedule transmission on a first transmit chain of the n transmit chains, and the second information is transmitted by the second device upon determining that band switching has been completed on the first transmit chain.

5. The communication device according to claim 4, wherein the band switching having been completed on the first transmit chain is determined based on a switch time corresponding to the first transmit chain.

6. The communication device according to claim 2, wherein the first information further comprises a first number, wherein the first number is a number of transmit chains of the first device after the first device is switched from the first band combination to the second band combination.

7. The communication device according to claim 1, wherein at least one of the first band combination or the second band combination comprises at least two bands.

8. The communication device according to claim 1, wherein
the first device is a terminal device, and the second device is a network device; or
the first device and the second device are two different terminal devices.

9. The communication device according to claim 1, wherein the first information is carried in capability information transmitted from the first device to the second device, wherein the capability information indicates a time required for switching to at least one band combination.

10. The communication device according to claim 1, wherein the first information is transmitted by the first device upon determining that the first device is switched from the first band combination to the second band combination.

11. A communication device, wherein the communication device is a second device and the communication device comprises:
a processor and a memory, wherein the memory is configured to store one or more computer programs, and the processor is configured to run the one or more computer programs to:
receive first information from a first device, wherein the first information indicates a time required for the first device to switch from a first band combination to a second band combination.

12. The communication device according to claim 11, wherein
the first device needs to perform band switching on n transmit chains to switch from the first band combination to the second band combination, n being a positive integer.

13. The communication device according to claim 11, wherein
the first information comprises a first switch time, wherein the first switch time is a maximum of switch times respectively corresponding to n transmit chains, wherein n is a positive integer; or
the first information comprises switch times respectively corresponding to the n transmit chains, and/or band pair information respectively corresponding to the n transmit chains, wherein the band pair information corresponding to each of the transmit chains indicates a band that the first device is switched from and a band that the first device is switched to on the transmit chain; or
the first information comprises a switch time corresponding to a first transmit chain of the n transmit chains, and/or band pair information corresponding to the first transmit chain, wherein the band pair information corresponding to the first transmit chain indicates a band that the first device is switched from and a band that the first device is switched to on the first transmit chain.

14. The communication device according to claim 13, wherein the processor is further configured to run the one or more computer programs to:
transmit second information to the first device upon determining that band switching has been completed on a first transmit chain, wherein the second information is configured to schedule transmission on the first transmit chain.

15. The communication device according to claim 14, wherein the band switching having been completed on the first transmit chain is determined based on a switch time corresponding to the first transmit chain.

16. The communication device according to claim 12, wherein the first information further comprises a first number, wherein the first number is a number of transmit chains of the first device after the first device is switched from the first band combination to the second band combination.

17. The communication device according to claim 11, wherein at least one of the first band combination or the second band combination comprises at least two bands.

18. The communication device according to claim 11, wherein
the first device is a terminal device, and the second device is a network device; or
the first device and the second device are two different terminal devices.

19. The communication device according to claim 11, wherein the first information is carried in capability information transmitted from the first device to the second device, wherein the capability information indicates a time required for switching to at least one band combination.

20. The communication device according to claim 11, wherein the first information is transmitted by the first device upon determining that the first device is switched from the first band combination to the second band combination.
